(19) United States
(12) Patent Application Publication
(10) Pub. No.: US 2012/0300781 A1
(43) Pub. Date: Nov. 29, 2012

(54) Packet Routing in a Network

(75) Inventors: Mikko Särelä, Kauniainen (FI); Petri Jokela, Espoo (FI); Pekka Nikander, Helsinki (FI)

(73) Assignee: TELEFONAKTIEBOLAGET L M ERICSSON (PUBL), Stockholm (SE)

(21) Appl. No.: 13/575,314

(22) PCT Filed: Dec. 10, 2010
(86) PCT No.: PCT/EP2010/069332

§ 371 Date: Jul. 26, 2012

Related U.S. Application Data
(60) Provisional application No. 61/299,550, filed on Jan. 29, 2010.

(51) Int. Cl. H04L 12/56

(52) U.S. Cl. 370/392

(57) ABSTRACT

A network node (4) is adapted to insert a collecting Bloom filter into a packet, and send the packet towards a second network node (8) by a hop-by-hop routing protocol. The network node (4) subsequently receives a packet sent by the second network node (8), with the header of the packet sent by the second network node containing a Bloom filter or Bloom Filter equivalent that encodes forwarding information from the second network node (8) to the network node (4). The Bloom filter or Bloom Filter equivalent received at the network node (4) may also encode forwarding information from the network node (4) to the second network node (8). In this case, the network node (4) may then determine, from the forwarding information in the Bloom filter or Bloom Filter equivalent, a first hop for forwarding packets towards the second node (8).

### TECHNICAL FIELD

The present invention relates to packet forwarding in a network. In particular it relates to a method in which forwarding information is contained in a packet header so that a network node may determine along which link(s) the packet should be forwarded from the forwarding information in the packet header.

### BACKGROUND

The Internet is based on open, “insecure” hop-by-hop routing, where each router makes the routing decision essentially separately for each packet, based on the destination IP address (and sometimes other header information) carried in the packet. Within such a networking environment, any end-node (host) can send packets to any other end-node, only subject to security measures imposed by specific extra network elements, such as firewalls or state-retaining network address translators (NATs). The network is “insecure” in the sense that the nodes within the network (routers) cannot verify whether the traffic is “authorised” in the sense that the receiver really wants to receive it.

Hence, as is well known, the Internet model is vulnerable to various unwanted traffic attacks, such as the well-known distributed denial-of-service (DDoS) attack, where a number of so-called “bot” end-nodes send unwanted packets to an attack target. Therefore the newer Internet protocols, such as the Mobile IPv6 protocol, have been designed in such a manner that they do not open new possibilities for sending unwanted traffic.

In the Internet, and more generally any network based on an open, “insecure” hop-by-hop routing approach, end-to-end mobility signalling security requires (weak) end-to-end authentication and a reverse routability test [Aura2004] (Tuomas Aura, Pekka Nikander, and Gonzalo Camarillo, “Effects of Mobility and Multihoming on Transport-Layer Security,” Proceedings of IEEE Symposium on Security and Privacy, Berkeley/Oakland, Calif., May 9-12, 2004, IEEE Computer Society) and [RFC 4225] (P. Nikander, J. Arkko, T. Aura, G. Montenegro, E. Nordmark, “Mobile IP Version 6 Route Optimization Security Design Background”, RFC4225, Internet Engineering Task Force, December 2005). The end-to-end authentication property is needed to ensure that mobility signalling is originated from the mobile host itself. The reverse routability test is required to ensure that the mobile host is reachable at the IP address it claims as its new location. This is important to prevent a (set of) dishonest mobile host(s) from claiming to be where they are not, thereby causing unwanted traffic to be sent by innocent by-hosts to an attack target.

Mobile IP [RFC 3775] (Johnson, D., Perkins, C., and J. Arkko, “Mobility Support in IPv6”, RFC 3775, June 2004) and HIP [RFC 5201] (Moskowitz, Nikander, Jokela, Henderson, “Host Identity Protocol”, RFC 5201, Internet Engineering Task Force, April 2008) and [RFC5202] (Nikander, Henderson, Vogt, Arkko, “End-Host Mobility and Multihoming with the Host Identity Protocol”, RFC 5206, Internet Engineering Task Force, April 2008) propose two slightly different solutions for internet-wide mobility signalling.

PCT/EP 2008/061167 and PCT/EP 2009/62785 propose a new packet forwarding method, based on including a Bloom Filter into a packet header. These in-packet Bloom Filters (hereafter “iBF”) each encode a specific path that the packet may take and will take through the network. Each forwarding node inspects the iBF and other fields in the packet header, determining from them the links over which the packet needs to be forwarded next.

In general, the iBF approach can be considered advantageous to the IP-based hop-by-hop routing and forwarding method in the sense that in the iBF approach the forwarding identifiers are bound to the location of the sender and, optionally, also to a specific path from the sender to a receiver, to a packet flow, or even to individual packets, as disclosed in PCT/SE2010/050001. Hence, while an IP address can be used to send any traffic from anywhere to the receiver (location) denoted by the IP address, an iBF can be used to send only specific traffic from a specific location to the receiver (location) denoted by the iBF. In that sense, the iBF method can be said to be more “secure” than the IP hop-by-hop method, in general.

Another advantageous aspect of the iBF method is that an iBF can specify a (small) multicast tree, thereby denoting a number of recipients instead a single one, without requiring any additional state in the network. This is in contrast with the IP multicast approaches, which require each multicast tree to be represented in the state of each participating forwarding node.

The original iBF forwarding was presented in [LIPSIN] (P. Jokela, A. Zahemszky, C. Esteve Rothenberg, S. Arianfar, P. Nikander, “LIPSIN: Line speed publish/subscribe inter-networking”, in Proceedings of ACM SIGCOMM 2009). As presented there, it was a source-routing-based forwarding solution that utilising statistically unique Link Identifiers instead of end-to-end addresses (e.g. IP addresses). The main idea in that paper was using in-packet Bloom filters to encode a source-routed path into a compact iBF.

An enhanced, more secure of version of the [LIPSIN] idea, called z-Formation, was presented in PCT/EP 2009/62785 and in [Z-FORMATION] (Christian Esteve and Petri Jokela and Pekka Nikander and Mikko Särelä and Jukka Ylitalo, “Self-routing Denial-of-Service Resistant Capabilities using In-packet Bloom Filters”, in proceedings of European Conference on Computer Network Defence (EC2ND) 2009). An enhanced, higher speed and more flexible variant was presented in PCT/SE2010/050001. These methods will be referred to as “secure” iBF-based forwarding.

Existing solutions have a number of problems, including the following:

In the current Internet, return routability requirement means that, at minimum, a mobile host needs 3 messages and 1.5 round trip times before it can resume direct communications with its corresponding hosts. In Mobile IP, before direct communications can be (re)established, traffic may be routed through the home agent, adding packet delay. In HIP, a rendezvous server may take a similar role. In either case, the added packet delay can present a problem for flows with real time traffic requirements.

Another problem with existing solution relates to communication with a moving host, where packets that are sent to a mobile host may be lost if the host has moved to a new location. It would be desirable to find a way of preventing this.

In the current Internet it is uneconomical to send packets to a small multicast group, as each multicast group requires explicit state in all participating routers. Hence, for example, supporting wide spread bi-casting (sending the same packets to two different locations), without relying on state on the routers, would require new packet formats that would carry two destination addresses and support for the new packet format at all potential branching points. Consequently, currently the only widely supported method for bi-casting is to send each packet twice, separately to both destination addresses.

### SUMMARY

The invention combines the routing and forwarding model used in the present Internet with a new, in-packet Bloom filters based forwarding model. As is explained below the combination has many advantages for example in (but not limited to) end-to-end mobility signalling.

A first aspect of the invention provides a network node adapted to insert a collecting Bloom filter into a packet, and send the packet towards a second network node by a hop-by-hop routing protocol. The node is also adapted to receive a packet sent by the second network node, the header of the packet sent by the second network node containing a Bloom filter or Bloom Filter equivalent that encodes forwarding information from the second node to the network node.

The term “send” is intended to cover both the case where the node is the originating node and generates and sends the packet, and the case where the node receives the packet from another node and sends on (or forwards) the packet after inserting the collecting Bloom filter.

The Bloom filter or Bloom Filter equivalent that encodes forwarding information from the second node to the network node may then be used in subsequent routing of packets, in place of IP routing such as hop-by-hop routing.

The network node may be further adapted to determine, from the forwarding information in the Bloom filter or Bloom Filter equivalent, a first hop for forwarding packets towards the second node.

The network node may be a mobile node, and is adapted to send the packet following a change in location of the mobile node. This allows generation of a Bloom filter or Bloom Filter equivalent that encodes forwarding information to the mobile node at its new location.

The Bloom filter or Bloom Filter equivalent may encode packet flow-specific forwarding information.

A second aspect of the invention provides a method of providing packet routing information, the method comprising inserting, at a first network node, a collecting Bloom filter into a packet. The packet is then sent from the first network node towards a second network node by a hop-by-hop routing protocol. The first network node subsequently receives a packet sent by the second network node, the header of the packet sent by the second network node containing a Bloom filter or Bloom Filter equivalent that encodes forwarding information from the second network node to the first network node.

The term “sent” is again intended to cover both the case where the node is the originating node and generates and sends the packet, and the case where the node receives the packet from another node and sends on (or “forwards”) the packet after inserting the collecting Bloom filter.

A third aspect of the invention provides a network node adapted to receive a packet sent by another network node according to a hop-by-hop routing protocol, the packet containing a collecting Bloom filter. The network node extracts from the received packet a Bloom Filter or Bloom Filter equivalent containing forwarding information from the network node to the another network node.

The network node may be adapted to determine, from the extracted Bloom Filter or Bloom Filter equivalent, a first hop for routing a packet towards the another network node.

A network node of the first or third aspect may extract a flow ID from the received packet, and associate the extracted Bloom Filter or Bloom Filter equivalent with the flow ID. This provides additional security.

A method of the second aspect may further comprise receiving, at the second network node, the packet sent by the first network node containing the collecting Bloom filter. The Bloom Filter or Bloom Filter equivalent containing forwarding information from the second network node to the first node is extracted from the packet at the second network node.

A fourth aspect of the invention provides a network node adapted to receive a packet sent by a first node according to a hop-by-hop routing protocol, the packet containing a collecting Bloom filter. The node inserts into the collecting Bloom filter a link identifier tag representing a link over which the packet is to be sent from that node, and forwards the packet towards a second node.

The network node may extract a flow ID from the received packet, and generate the link identifier tag such that the link identifier tag is associated with the flow ID.

The network node may generate a bidirectional link identifier tag.

A method of the second aspect may further comprise receiving, at an intermediate node, the packet sent by the first node containing the collecting Bloom filter. At the intermediate node, a link identifier tag representing a link over which the packet is to be sent from that node is inserted into the collecting Bloom filter. The packet is forwarded towards the second node.

The method may comprise generating a bidirectional link identifier tag for insertion into the collecting Bloom filter.

The Bloom filter or Bloom Filter equivalent may encode forwarding information from the second network node to the first network node and forwarding information from the first network node to the second network node.

The method may further comprise determining, from the forwarding information in the Bloom filter or Bloom filter equivalent, a first hop for forwarding a packet from the first node to the second node. Additionally or alternatively it may comprise determining, from the forwarding information in the Bloom filter or Bloom filter equivalent, a first hop for forwarding a packet from the second node to the first node.

In the third aspect of the invention, the another network node may be a mobile node, which sends the packet following a change in the location of the mobile device. In this aspect the Bloom Filter or Bloom filter equivalent contains forwarding information from the network node to the mobile node at its new location.

The network node may be adapted to determine, from the forwarding information in the Bloom Filter or Bloom filter equivalent, a first hop for forwarding a packet from the network node to the mobile node at its new location.

The network node may be adapted to send a packet towards the mobile node using both the Bloom Filter or Bloom filter equivalent containing forwarding information from the network node to the mobile node at its new location and a Bloom Filter or Bloom filter equivalent containing forwarding information from the network node to the mobile node at an old location.

A fifth aspect of the invention provides a method of routing packets to a mobile node, the method comprising sending, from a corresponding node, packets towards a mobile node using a first Bloom filter or Bloom filter equivalent that encodes forwarding information towards the mobile node. Following a change in the location of the mobile node, a packet sent from the mobile node to the corresponding node by a hop-by-hop routing protocol and packet containing a collecting Bloom filter is received at the corresponding node. A second Bloom Filter containing forwarding information from the corresponding node to the mobile node at its new location is extracted, at the corresponding node, from the packet sent from the mobile node.

A further aspect of the invention provides a computer-readable medium containing instructions that, when executed by a processor, cause the processor to perform as method of the second or fifth aspect.

The invention also provides a method of providing packet routing information, the method comprising sending, by a hop-by-hop routing protocol from an first node, a packet to a second node, the packet containing a collecting Bloom filter. At an intermediate node, a link identifier tag representing a link over which the packet is to be forwarded from that node is inserted into the collecting Bloom filter. At the second node, a Bloom Filter or Bloom filter equivalent containing forwarding information from the second node to the first node is extracted from the packet.

The invention also provides a method of routing packets to a mobile node, the method comprising routing packets from a corresponding node to a mobile node using a first Bloom filter or Bloom filter equivalent. At a time after a change in the location of the mobile device, a packet is sent from the mobile node to the corresponding node by a hop-by-hop routing protocol, the header of the packet containing a collecting Bloom filter or Bloom filter equivalent. At the corresponding node, a second Bloom Filter or Bloom filter equivalent containing forwarding information for at least a path from the corresponding node to the mobile node at its new location is extracted from the packet.

Additionally, the use of iBFs may enable operators to prioritize traffic carrying an iBF over other traffic, and thereby protect customers from unwanted traffic (not carrying valid iBFs) more efficiently than is possible today.

In this invention, we present a method that cuts both the need for return routability tests, thereby reducing the mobility handover delay from 1.5 RTTs to 0.5 RTT, and allows efficient bi-casting, thereby reducing the probability of packet loss in handover situations.

### BRIEF DESCRIPTION OF THE DRAWINGS

Preferred embodiments of the present invention will be described by way of example with reference to the accompanying figures in which:

FIG. 1 illustrates the basic principles of an iBF-based routing method;

FIG. 2(a) illustrates the dynamic computation of a link identifier;

FIG. 2(b) is a schematic view of a network node that uses iBF-based routing;

FIG. 3 illustrates collection of an iBF as a packet passes through a network using hop-by hop routing;

FIG. 4 illustrates routing packets to a mobile host;

FIG. 5 is a block flow diagram of a method according to the present invention;

FIG. 6 is a block flow diagram of a method according to the present invention;

FIG. 7 is a block flow diagram of a method according to the present invention;

FIG. 8 is a block flow diagram of a method according to the present invention;

FIG. 9 is a block flow diagram of a method according to the present invention;

FIG. 10 is a block flow diagram of a method according to the present invention;

FIG. 11 is a schematic illustration of routing packets by a method of the invention; and

FIGS. 12(a), 12(b) and 12(c) are schematic views of network nodes of the present invention.

### DETAILED DESCRIPTION

The present invention will be described with reference to embodiments in which the routing information for a packet is contained in the packet in a Bloom Filter. However, the invention is not limited to a Bloom Filter, and other compact representations comprising encoding routing information into a set membership that can be interrogated to identify a routing information similar to using a Bloom Filter in functionality may be used such as, for example, the representation described by A Pagh et al. in “An Optimal Bloom Filter Replacement”, Proceedings of the sixteenth annual ACM-SIAM symposium on Discrete algorithms, pages 823-829 (2005). The invention may also be effected with modified Bloom filters such as disclosed by, for example, M. Mitzenmacher in “Compressed Bloom Filters”, IEEE/ACM Transactions on Networking, Vol. 10, No. 5, p604 (2002).

The present invention makes it possible to combine “secure” iBF-based forwarding, for example as described in PCT/EP 2009/62785, and another, e.g. IP-routing-based, hop-by-hop routing and forwarding method. As preferred embodiments, methods will be described where the Internet Protocol (IP), and optionally the present Internet, implements the hop-by-hop routing and forwarding. First, for “secure” iBF-based forwarding, the application will describe so-called “underlay forwarding”, where each IP router is assumed to be enhanced with an iBF-based forwarding plane. Second, the application will also describe “overlay forwarding”, where selected IP routers or middle boxes are enhanced with an iBF-based forwarding mechanism.

In a general overview, the principle of a method of the invention is as follows:

1. When a first end-node “Alice” wants to send a packet to a second end-node “Bob”, and Alice does not have a functional iBF for the path from Alice to Bob, Alice sends packets towards Bob using the hop-by-hop routing and forwarding mechanism. As these packets pass through iBF-enhanced nodes, any of the packets may have a “collecting” iBF field, so that routing information for the path becomes encoded into the collecting iBF field, as the packet traverses the path.

2. When Bob receives a packet from Alice that has such a “collecting” iBF field, he can assume that the iBF can be used to send packets back to Alice, bypassing the need to use hop-by-hop routing.

3. When Alice receives from Bob a packet that Bob sent using the collected iBF there are two possibilities. One, if the iBF collected when the packet travels from Alice to Bob is “bidirectional”, Alice can assume that the iBF in the received packet can be used to send packets back to Bob, again bypassing the hop-by-hop routing. The other possibility, if the iBF collected when the packet travels from Alice to Bob is not bidirectional, is for Bob to include another “collecting” iBF field in a packet that he sends to Alice; Alice may then use the iBF in the “collecting” iBF field of the received packet to send packets back to Bob, again bypassing the hop-by-hop routing.

An important aspect of the present invention is that the collected iBFs can only be used to send traffic along the collected path, and depending on details and the direction of collection, either in the forward direction (A→B), reverse direction (B→A), or both (B<—>A). It is noteworthy that, owing to the way iBFs are constructed, an iBF cannot be used to send any (meaningful) traffic between any other locations. (As is known, when retrieving information encoded into a Bloom filter there is a non-zero probability of a “false positive” which, in the context of packet routing, would lead to a packet being forwarded along an unintended path as well as along the intended path. However, it will be assumed that the invention makes use of Bloom filters for which the probability of a “false positive” can be ignored.)

Hence, as a consequence of the way how the iBFs are collected, constructed, and used for forwarding, the combination of iBF-based forwarding and IP-based routing removes the need for the return routability signalling, thereby speeding up handovers with a global mobility management protocol.

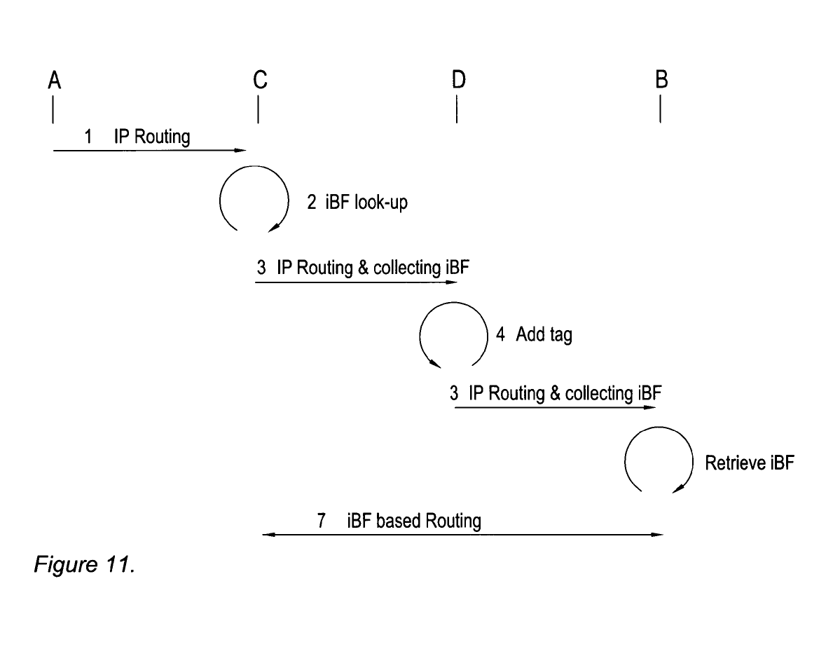

In more detail, a preferred embodiment of the invention involves the following steps, as shown in FIG. 11:

An end-node A needs to send a packet to end-node B. At step 1 node A sends a legacy IP packet with A as the source IP address and B as the destination IP address.

The first iBF-enhanced node along the IP-routed path, which in the example of FIG. 11 is node C but which in other implementations may be node A itself, tries to look up an iBF for the path A→B at its internal database. If node C does not find an iBF for the path A→B, it adds an empty “collecting” iBF field to the packet at step 2. Node C then forwards the packet towards node B, by an IP routing protocol (such as hop-by-hop routing) at step 3.

If node C, the first iBF-enhanced node along the IP-routed path, does find an iBF for the path A→B, it can then send the packet to node B by inserting this iBF into the packet header and sending the packet according to a known iBF routing technique.

If a packet has a “collecting” iBF field, each iBF-enhanced router en-route calculates the next hop iBF tag for the flow and adds the tag into the “collecting” iBF field. At step 4 of FIG. 11 node D, which is a node on the path from node C to node B, add the next hop iBF tag into the “collecting” iBF field of the packet. Node D then forwards the packet towards node B, by an IP routing protocol (such as hop-by-hop routing) at step 5.

Once the last iBF-enabled node, which may be B itself, receives the packet, the packet contains, in the “collecting” iBF field, a collected iBF that can be used for sending packets along the path B→C, or along both the path C→B and the path B→C, depending on the exact details on how the iBF was collected. In the example of FIG. 11 node B is the last iBF-enabled node, and at step 6 node B retrieves the collected iBF for use in future iBF-based routing, shown schematically as 7. (If node A itself is an iBF-enhanced node, the iBF-based routing at 7 would be between node A and node B.)

It should be noted that although FIG. 11 shows the end node B as the last iBF-enabled node on the path to node B, the invention is not limited to this. For example if the last iBF-enabled node was a node E between node D and node B, node E would retrieve a collected iBF for routing along the path E→A, or along both the path A→E and the path E→A, and routing between node E and node B would be performed by an IP routing protocol. That is, the collected iBF may either be used for routing over part of the path from node B to node A, or it may be used for routing over the entire path from node B to node A.

As noted above, a further feature of the invention is that an iBF may be used for bi-directional traffic, while in the prior methods of iBF-based routing it has only been possible to use an iBF for unidirectional traffic.

It is noteworthy that the iBF can be used only for packets along the paths A→B and B→A. If any other node but A or B sends a packet with the said iBF, there is a very high probability that the packet is dropped. Furthermore, if A or B sends a packet with the said iBF but with the IP header containing any other addresses but the ones defined during the iBF collection phase, again there is a very high probability that the packet is dropped.

Furthermore, it is noteworthy that if A and B create an (anonymous) authenticated end-to-end communication channel, when A moves, A can just send a packet to B indicating that A has moved and B can immediately start sending using the new iBF, and vice versa. The reason for this is that the authenticated channel allows B to make sure that whoever claims to be A at the new location is really A (and vice versa), and that the new iBF by itself acts as a proof that the network from which the message was sent is reachable using the iBF and hence suggests that A is reachable via the route encoded into the iBF.

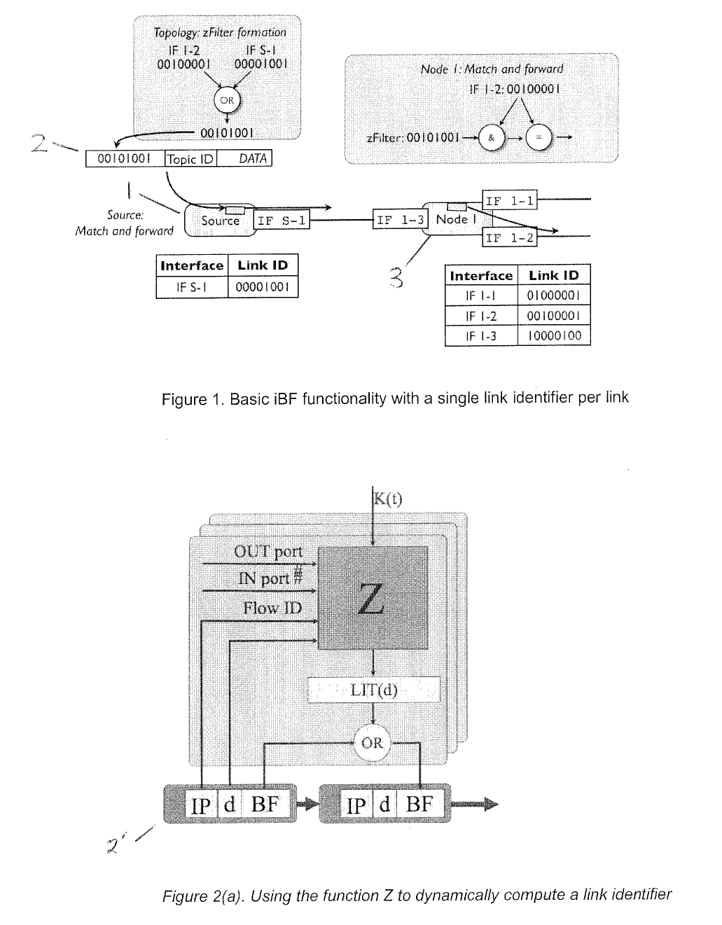

FIG. 1 shows the general principle of Bloom filter based routing, according to LIPSIN ([LIPSIN] and PCT/EP 2009/62785). LIPSIN described a packet forwarding mechanism based on Link Identifiers (LIDs), instead of IP (or other types of end-to-end) addresses. The principle is to build a forwarding path on the Topology layer, or at a separate path computation element (such as a Topology Manager), the forwarding path containing a set of nodes through which a packet needs to pass on its way from the source to the destination. From this set of nodes, the required LIDs—that is, the Link Identifiers of the links that make up the forwarding path—are determined and are used to construct a Bloom filter, making a compact representation of the forwarding tree. In FIG. 1 the Bloom filter is generated at a source node 1, in the example shown by “OR-ing” the LIDs of the links forming the forwarding path. This Bloom filter, or “iBF”, is put into the header of a data packet 2 to be sent out from the source node. The packet 2 is shown as containing a Flow ID which identifies the particular packet flow, and data.

The LID of a link may be any identifier that is suitable to identify the link. For example, a link may be allotted an LID. As another example, the LID of a link from a first node to a second node may be derived wholly or partially from the identifier of the outgoing port (or output interface) of the first node from which packets are sent over the link and/or from the identifier of the ingoing port (or input interface) of the second node on which packets are received over the link. An LID is typically a string of binary digits (eg a string of 256 digits)

Each router 3 on the path performs a matching operation on the iBF in a received packet, to check if the LID of any of its own outgoing interfaces had been included in the iBF carried in the packet. If this is the case, the packet is forwarded out of that interface(s). As a result of this mechanism, forwarding is a very efficient operation in [LIPSIN], consisting (in the basic form) of one bit-wise AND and one comparison operation. In the example of FIG. 1, the packet received at the router 3 contains the iBF 00101001. The LID for the link IF1-2 (00100001) is included in the iBF, so the packet is routed along the link IF1-2. However, the LIDs for the link IF1-1 (01000001) and the link IF1-3 (10000100) are not included in the iBF, so the packet not routed along these links.

In a modification of this basic Bloom filter based routing method, a plurality of link identifier tags (LITs) are generated for each LID. For example each link in the network may have d LITs (LIT1, LIT2, . . . LITd). An LIT is a compact representation of the LID. This makes it possible to generate d candidate Bloom filters, each of which represents the same forwarding tree. One of the candidate iBFs is selected according to some policy (for example the candidate iBF with the lowest risk of false positives may be selected) and used for routing. In this modification, a packet contains an indication of the d-value used, so that forwarding nodes can use the correct LIT.

The basic method described in LIPSIN is developed in [Z-FORMATION] and PCT/EP 2009/62785. In the method of [Z-FORMATION] and PCT/EP 2009/62785, instead of maintaining an explicit forwarding table that contains a number of Link identifiers (or Link Identifier Tags) for each outgoing interface, the presented approach was based on dynamically computed, per-flow or per-packet link identifiers. For each incoming packet, a fixed function, referred to as the “Z function” was used to compute the corresponding link identifiers using
(i) a periodically changing secret key K,
(ii) some in-packet information I (a flow or per-packet identifier), and
(iii) the incoming and outgoing interface indices (IN, OUT).

That is, LIT=Z (I, K(t), IN, OUT), where Z denotes the function that determines the LIT from the interface indices IN, OUT, the in packet information I and the secret key K(t).

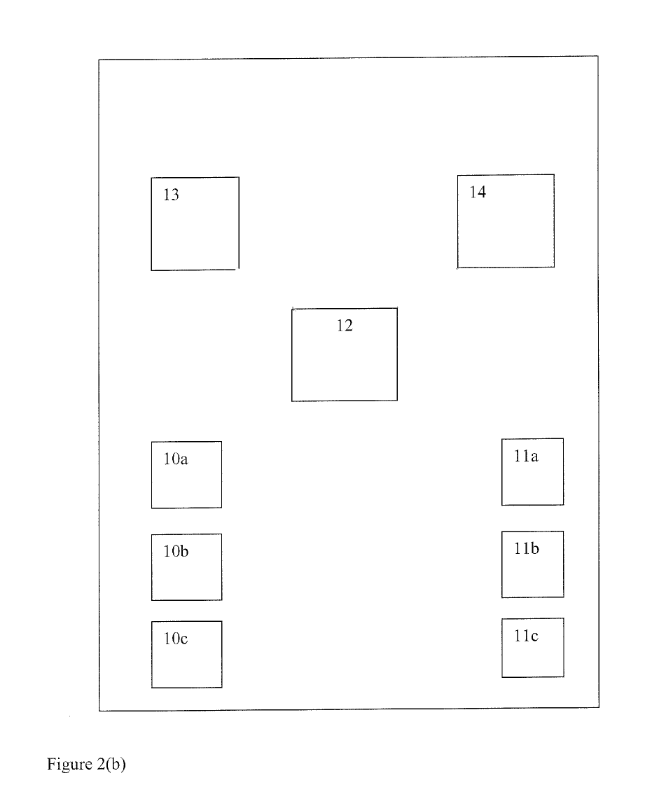

The in-packet information may optionally also include a “d value” to allow d different Z-functions to be used for additional security. In this case, as shown in FIG. 2(a):

LIT(d)=Z (IN, OUT, I, K(t)), where Z is one of the d candidate Z functions, and is selected by the d value in the incoming packet.

The function Z of FIG. 2(a) produces a dynamically computed link identifier tag. FIG. 2(a) illustrates generation of an LIT for a path where a packet 2 is received at a node on the forwarding path, at an input port identified by an input port number IN. The packet contains information that identifies the packet or the packet flow, and optionally a “d value”. The packet 2 is destined to be sent from the node from an output port identified by an output port number OUT. As in LIPSIN, each LIT that is generated according to: LIT(d)=Z_{d} (I, K(t), IN, OUT) is a string of binary digits of length m.

As the generated LIT is a string of binary digits it can be added to a Bloom filter for example using the OR operation. This is also shown in FIG. 2(a), which shows a packet 2′ that contains a collecting Bloom filter received at the node along the forwarding path. The LIT value is computed as described above, and is then inserted into the collecting Bloom filter of the packet, for example using the OR operation.

As the iBF is now constructed using dynamic link identifiers instead of static link identifiers, the resulting iBF became bound to the flow ID or other in-packet information I, a specific time period, and the input interface index, in addition to being bound to the output interface index, as in [LIPSIN]. Especially, having the Flow ID or other in-packet information I as an input parameter tied the given iBF to only those packets carrying the specified Flow ID and so provided additional security.

FIG. 2(b) is a schematic illustration of a network node that is able to use iBF-based routing. The node 9 contains a plurality of input ports 10a, 10b, 10c and a plurality of output ports 11a, 11b, 11c. (The ports are shown as either input ports or output ports for simplicity, but in principle a port could act as both an input port and an output port.) The node 9 further contains a routing module 12. When a packet is received at one of the input ports 10a, 10b, 10c, the routing module determines which output port(s) the packet should be forward from. The routing module may do this by, for example, querying the iBF in the received packet to determine which of the node's outgoing links have their LIT encoded in the iBF, and forwarding the packet to the output port(s) corresponding to the link(s). (If the result of querying the iBF does not retrieve an LIT for any of the node's outgoing links, the packet is dropped.)

The node 9 may also include a computation module 13 for dynamically computing LITs as described with reference to FIG. 2(a). Additionally or alternatively it may include a memory 14 for storing the LITs of its outgoing links, for example in the form of a look-up table.

While the method described in [LIPSIN] was originally designed to be used in a pub/sub style networking with separate rendezvous and topology functions, it is possible to use it also in other types of networks. From that point of view, in this invention we utilise hop-by-hop IP forwarding as a topology function and each target end-node as the rendezvous point.

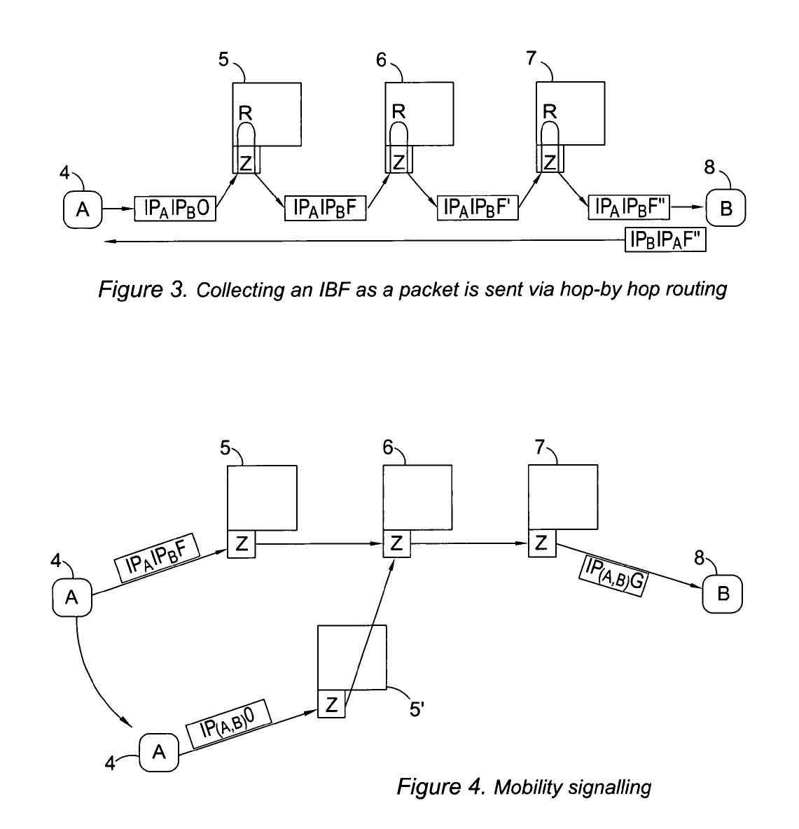

Collecting an iBF through hop-by-hop routing will now be described. According to this aspect of this invention, we consider a case where a first end-host 4 such as host A in FIG. 3 has a packet to be sent to a second end host 8 such as host B in FIG. 3 using the source IP address IP_{A} and destination IP address IP_{B}, and where said first end-host 4 does not have any working iBF for sending said packet to said second end-host 8. In such a situation, said first end-host 4 may send the packet through the hop-by-hop routing infrastructure, and it may attach a “collecting” iBF to the packet. The collecting iBF is initialised to zero.

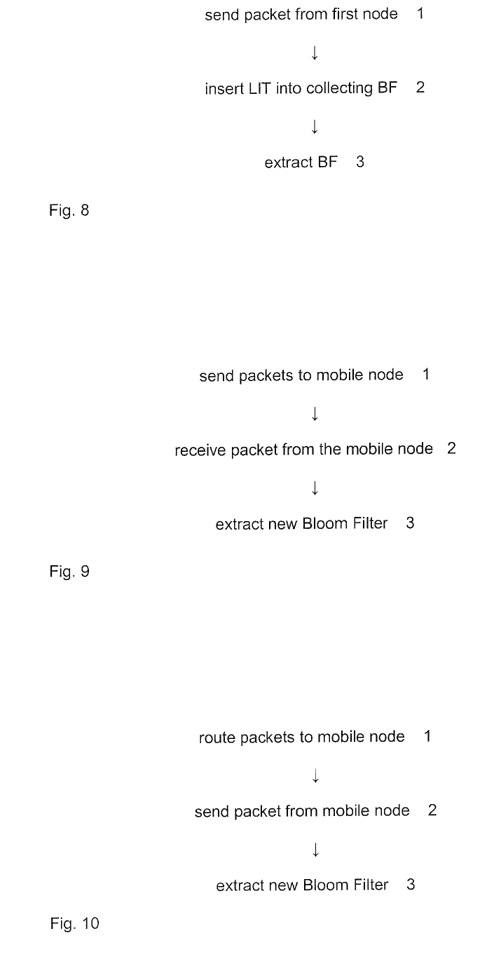

FIG. 8 is a block flow diagram illustrating the principal processes in the method of FIG. 3. Initially the first end host 4 sends (1) the packet towards the second end host 8, with the packet containing a collecting Bloom filter (which is initialised to zero). At a forwarding node on the path, an LIT is inserted (2) into the collecting Bloom filter. The packet is eventually received (3) at the second end host, which extracts the Bloom filter from the packet. The extracted Bloom filter that encodes at least forwarding information from the second end host to the first end host (and may optionally be a “bidirectional” Bloom filter that encodes forwarding information from the second end host to the first end host and encodes forwarding information from the first end host to the second end host).

In the example of FIG. 3 it is assumed for the purposes of description that the first end-host 4 and the second end host 8 are the originating host and the destination host of the packet respectively, so that the path from the first end-host 4 to the second end host 8 is the entire packet path. The invention is not however limited to this, and it is alternatively possible that the first end host 4 is not itself the originating host of the packet but receives the packet from an originating host (not shown) by another routing method such as an IP-based routing method and/or that the second end host 8 is not itself the destination host of the packet but forwards the packet to a destination host (not shown) by another routing method such as an IP-based routing method. In general terms, the invention may be applied wherever some part of the path between the originating host and the destination host can support iBF-based routing, even if the originating host and/or the destination host is not itself an iBF routing enabled host.

In FIG. 3, the first end host 4 sends a packet towards the second end host 8 by hop-by-hop routing. The packet sent by the first end host contains in its header, as shown schematically in FIG. 3, at least the IP address IP_{A} of the first end host 4, the IP address IP_{B} of the second end host 8, and the collecting Bloom filter which, at this stage is initialised to zero. The packet is received at a forwarding node 5, which is an intermediate node on the path from the first end host 4 to the second end host 8, and this is shown as (1) in FIG. 7 which is a block flow diagram illustrating the principal processes carried out at the forwarding node 5 of FIG. 3. As the packet arrives at a forwarding node 5 within the hop-by-hop routing infrastructure, the forwarding node 5 first makes a routing decision according to the usual hop-by-hop routing algorithms. For example, if the packet is an IP packet and the hop-by-hop routing infrastructure is an IP network, the forwarding node 5 typically makes a longest prefix match to the destination IP address in the IP packet header, and picks up the outgoing link associated with the longest matching IP prefix in its forwarding table.

Once the forwarding node 5 has made its hop-by-hop forwarding decision and knows the outgoing link for the packet, it computes the local LIT value that it expects to see in any future packets. Preferably the forwarding node 5 computes a flow-dependent local LIT value—that is, it computes the local LIT value that it expects to see in any future packets of the same flow. For example, in the case of IP routing, the Flow ID may consist of the source and destination IP addresses, the protocol value, and optionally the protocol port numbers for protocols such as UDP and TCP that carry protocol port numbers, and/or optionally other fields from the IP or other headers.

In an optional embodiment, in the case of IP traffic, to make it possible to use the iBF that is collected for the future sending of packets in both directions along the path, the source and destination IP addresses, the corresponding protocol port numbers (if any), and the input and output link interface indices, must be ordered, numerically or otherwise, in such a way that they form the same Flow ID independent of which direction the packet is flowing through the node.

Next, the forwarding node 5 inserts ((2) in FIG. 7) the computed LIT value for the outgoing link to the “collecting” iBF in the packet. In the typical case, it simply performs a bit-wise binary OR operation on the bits already in the collecting iBF and the bits in the newly computed LIT value (as shown in FIG. 2). Alternatively, a counting Bloom filter or some other format may be used for the “collecting” iBF.

The packet is then forwarded ((3) in FIG. 7) to the next forwarding node 6. The packet sent by the first forwarding node 5 contains the collecting Bloom filter which now includes the LIT added by the forwarding node 5—the collecting Bloom filter is therefore now denoted by “F”. The next forwarding node 6 repeats the process described for the forwarding node 5 and forwards the packet to the next forwarding node 7. The packet sent by the next forwarding node 6 contains the collecting Bloom filter which now includes the LIT added by the forwarding node 5 and the LIT added by the forwarding node 6—the collecting Bloom filter is therefore now denoted by “F”. The process is repeated for each forwarding node—each hop-by-hop forwarding node adds the corresponding link identity tag (LIT) to the iBF enroute.

When the packet reaches its hop-by-hop destination, ie the second end host 8, it will contain in the “collecting” iBF field a usable iBF for sending packets along the path it has traversed. Depending on the details of how the iBFs are used and how the collection phase works, the resulting iBF may be used on the path in the reverse direction (ie from the second end host 8 to the first end host 4) or in both directions. Thus, as shown in FIG. 6, which is a block flow diagram illustrating the principal processes carried out at the second end host 8 of FIG. 3, the second end host receives (1) a packet that was sent by the first end host 4 and extracts (2) a Bloom filter from the packet. The Bloom filter encodes at least forwarding information from the second end host to the first end host (and may optionally be a “bidirectional” Bloom filter that encodes forwarding information from the second end host to the first end host and encodes forwarding information from the first end host to the second end host).

It should be noted that the invention is not limited to the forwarding nodes 5, 6, 7 inserting the computed LIT value for the outgoing link to the “collecting” iBF in the packet. For example, the forwarding node could alternatively add a computed LIT value for the incoming link, that is the link over which the packet was received at the forwarding node 5, 6, 7, by reversing the relevant parts of the computational and checking logic. This is known as “reverse-path collection”. As a further example, the forwarding node could alternatively add an LIT value that is computed based on both the ingoing link and the outgoing link, and this is known as “bi-directional path collection”. In general, the forwarding nodes may insert entries into the collecting iBF in any suitable way that leads to a resulting iBF that may be used on the path in the reverse direction (ie from the second end host 8 to the first end host 4) or in both directions—the LIT generated at a node may be defined to be the outcome of the function used at the node to compute the bits used in Bloom filter matching, and each node adds the LIT it has generated to the collecting Bloom filter.

The second end-host may then use the collected iBF to send a packet to the first end host 4 according to an iBF-based routing method. If the collected iBF is “bidirectional”, the first end host 4 may, when it receives a packet from B that contains collected iBF in its header, retrieve the iBF from the packet. The first end host 4 and the second end-host 8 are then both able to use iBF-based routing between one another. The first end host 4 can determine, from the forwarding information in the Bloom filter, a first hop for forwarding packets towards the second end host 8. This applies whether the first end host 4 is itself the source of the packet (in which case the first end host 4 would generate a packet, insert the iBF into the packet header, and send the packet) or whether the first end host is forwarding a packet it has received from another node (in which case the first end host 4 would insert the iBF into the header of the received packet, and send on the packet).

If the collected iBF is not “bidirectional” the second end host 8 may, when it sends a packet to the first end host 4, also insert a collecting iBF into the packet so that an iBF for the direction node A to node B is collected by a process that is reverse to the process described above.

Whether or not the collected iBF is “bidirectional”, the second end host 8 can determine, from the collected iBF, a first hop for routing a packet towards the first end host 4. This applies whether the second end host is the source of the packet (in which case the second end host 8 would generate a packet, insert the iBF into the packet header, and send the packet) or whether the second end host is forwarding a packet it has received from another node (in which case the second end host 8 would insert the iBF into the header of the received packet, and send on the packet).

In a case where the collected iBF(s) are flow-dependent, the collection process is repeated for each flow.

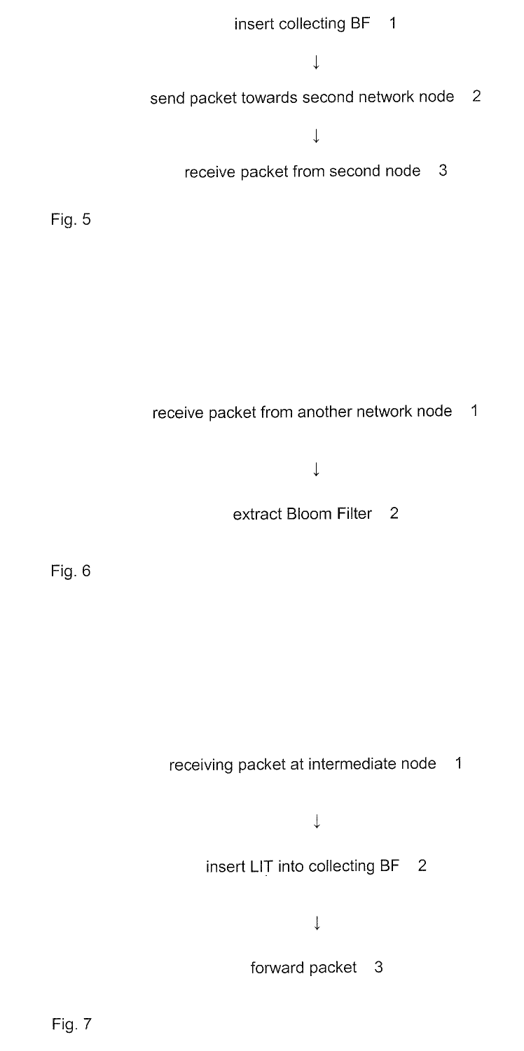

FIG. 5 is a block flow diagram illustrating the principal processes carried out at the first end host 4 of FIG. 3. Initially the first end host inserts (1) a collecting Bloom filter (which is an array of binary digits initialised to all zeroes) into a packet, and send (2) the packet towards the second end host (2). Subsequently, the first end host receives (3) a packet back from the second end host, which packet contains a Bloom filter that encodes at least forwarding information from the second end host to the first end host (and that may optionally be a “bidirectional” Bloom filter that encodes forwarding information from the second end host to the first end host and encodes forwarding information from the first end host to the second end host). The first end host may then optionally extract the forwarding information in the received packet, preferably by extracting the Bloom filter and storing it for use it in further communications to the second end host.

As briefly mentioned above, the LIT values, which together along the path form the iBF, are typically calculated based on the indices of outgoing and incoming physical (or logical) links and certain fields from the transport/IP header, e.g. the so-called IP tuple which consists of the IP source and destination addresses, the protocol number, and in the case of protocols that have them, the protocol source and destination port numbers. For the rest of the application, however, we shall assume for ease of description that the protocol number and the upper layer protocol numbers are excluded from the Flow ID, i.e. that only IP_{S} and IP_{D} are used to form the Flow ID. It is easy for a person knowledgeable in the art to understand that the Flow ID may contain additional values, and in the case where the values need to be ordered depending on the direction of the packet, how the additional values should be ordered so that they are packet-direction independent.

Forming bi-directional iBFs will now be described. In one embodiment in which the iBF is formed in a direction-independent manner and numerical ordering is used, the Flow ID may be computed in following manner:

if IP_{S}>IP_{D} then

Flow ID=IP_{S}|IP_{D}, and therefore LIT=Z(IP_{S}|IP_{D},K(tᵢ),In,Out);

else

Flow ID=IP_{D}|IP_{S}, and therefore LIT=Z(IP_{D}|IP_{S},K(tᵢ),Out,In)

In these expressions, IP_{S} is a source IP address, IP_{D} is a destination IP address, K(tᵢ) is the secret key in the router (which is changed periodically), In is the interface (or peer) from which the packet arrived, and Out is the interface (or peer) to which the packet is forwarded.

Note, however, that the exact method of ordering the fields in a direction independent manner is a local matter to the forwarding node, and may vary between forwarding nodes within a single system.

The above collection process can be easily modified to include the use of Cryptographic Bloom Filters as taught for example in PCT/SE2010/050001, when the teaching of PCT/SE2010/050001 is used to specify flow-specific iBFs. In PCT/SE2010/050001, a semi-dynamic parameter O2 is computed for each hop in a path, based on a pre-defined router-assigned key. The semi-dynamic parameters for a path are provided to the sending end-node of the path, and the sending end-node then calculates a dynamic parameter O3 for each hop in the path based on the semi-dynamic parameters O2 and on packet-specific information related to a data packet. The data packet is then sent, with the computed dynamic parameters O3 and the packet-specific information over the path. In a preferred embodiment, the method of PCT/SE2010/050001 computes a semi-static parameter O1 for each hop in the path based on the pre-defined router-assigned key, and the semi-dynamic parameter O2 for a hop is calculated based on the corresponding semi-static parameter. By using the semi-static parameters O1 (if present), the semi-dynamic parameters O2 and the dynamic parameters O3 in this way, the routing information embedded in each packet can be well-protected by using relatively strong cryptographic functions for computing O1 and O2, respectively, while the forwarding operation can be facilitated by using a “lighter” cryptographic function for computing O3.

Where a method of the present invention is combined with the teaching of PCT/SE2010/050001, in that case PCT/SE2010/050001 is merely used as a specific way to implement the function Z.

If it is desirable to use the teachings of PCT/SE2010/050001 in a way where the sending end node, e.g. node A in FIG. 3, computes a per-packet-specific iBF as also proposed in PCT/SE2010/050001, the hop-by-hop iBF collection of FIG. 3 cannot be used as such. Instead, the “collecting” iBF field can no longer be an iBF, but the corresponding field shall carry all the semi-dynamic parameters O2 generated by each of the routers en-route. In this case, combination of the per-packet-specific iBF of PCT/SE2010/050001 and the present invention may require some modification to the described method of FIG. 3.

In a combination of the per-packet-specific iBF of PCT/SE2010/050001 and the present invention, the routers also preferably store or cache their computed semi-dynamic parameters O2.

Use of an iBF for source-routed forwarding will now be described. When a forwarding node receives a packet that contains a routable iBF, it may forward it according to one of the methods described in PCT/EP 2009/62785, PCT/EP 2009/62785, or PCT/SE2010/050001. However, in this application we also consider the case of bi-directional iBFs, defined above. In any case, when a packet containing a routable iBF is forwarded, the forwarding node computes the same LIT value for the packet as it did for the initial packet on the same flow.

Compared to hop-by-hop routing, this approach is expected to be beneficial as the iBF-based forwarding decisions require less memory and are simpler than the typical hop-by-hop routing-based forwarding decisions.

According to a further feature of the present invention, it is possible to apply the present invention to speed up node mobility management, and this “mobility signalling” will now be described.

In this section we describe how the hop-by-hop iBF collection, as set out above, and source-routed iBF forwarding can be used together to speed up global, end-to-end mobility signalling. As is customary to IP mobility protocols, such as Mobile IP, we consider the signalling and packet flow between a mobile end-node (“MN”) such as node 4 of FIG. 4, and a stationary corresponding end-node (“CN”) such as node 8 of FIG. 4.

Initially, when MN wants to communicate with the CN, it sends a packet via hop-by-hop routing, triggering iBF collection at intermediate nodes 5, 6, 7 as explained with reference to FIG. 3 above. Once the iBF (or two iBFs in the case of uni-directional iBFs) has/have been collected, the iBF(s) can be used to exchange packets directly between the mobile node 4 and the corresponding end node 8, bypassing the hop-by-hop routing, as defined above. FIG. 4 assumes that a bi-directional iBF is collected, and thereby the initially collected iBF is denoted as “F” in FIG. 4.

When the MN moves to a new location (or, strictly, when the location of the MN changes from the point of view of network topology), the iBF can no longer be used to route packets between the MN and the CN or vice versa, as the iBF is bound to the actual packet path. (This would also be the case if two uni-directional iBFs had been collected). Hence, upon or after arrival at the new location, the MN needs to again send a packet via the hop-by-hop routing mechanism, triggering a new iBF collection phase. In FIG. 4, the path from the new location of the mobile node 4 to the corresponding node 8 is a different path from the path from the old location of the mobile node 4 to the corresponding node 8—in FIG. 4 the new path is shown as passing through nodes 5′, 6 and 7 whereas the path from the old location of the MN passed through nodes 5, 6, 7. In the meanwhile, the CN will continue to send the packets with the old iBF “F”, causing them to be delivered to the old location of the MN (where they would be dropped).

As the first packet sent by the MN at its new location reaches the CN, it contains a new iBF, denoted in FIG. 4 as “G”. As this new iBF is bound to the path between the new location of the MN and the location of the CN (ie, the path via nodes 5′, 6, 7) it can be used directly, without any return routability check. That is, once CN has received a packet with a new collected iBF, it can immediately use the new iBF to send packets back to the MN, by determining from the forwarding information in the iBF a first hop for forwarding a packet towards the mobile node at its new location. The packets sent by the CN will go back to the source of the packet received from the MN (that is, to the new location of the MN) and, with high probability, only to the source of the received packet.

FIG. 9 is a block flow diagram illustrating the principal processes carried out at the corresponding node 8 of FIG. 4, and FIG. 10 is a block flow diagram illustrating the principal processes carried out in the method of FIG. 4. Initially, the corresponding node routes ((1) of FIGS. 9 and 10) packets to the mobile node at the old location of the mobile node, using a Bloom filter encoding forwarding information to the mobile node at its old location—for example, using a Bloom filter extracted from the packet that was sent by the mobile node at its old location. When the mobile host 4 changes its location, on or after arrival of the mobile node 4 at its new location it sends ((2) of FIG. 10) a packet to the corresponding node. This packet contains a collecting Bloom filter, initialised to all zeroes. Subsequently the corresponding node receives ((2) of FIG. 9) the packet sent by the mobile host on or after arrival of the mobile node 4 at its new location. This packet contains a collecting Bloom filter and the corresponding node extracts ((3) of FIGS. 9 and 10) a new Bloom filter that encodes at least forwarding information from the corresponding node to the mobile node at its new location (and that may optionally be a “bidirectional” Bloom filter). The corresponding node 8 may then use the new Bloom filter to route packets to the mobile node 4 at its new location (and, if desired, may also continue to use the previous Bloom filter to route packets to the mobile node 4 at its old location).

The other requirement for securing end-to-end mobility, authentication, can be fulfilled in a number of ways, and authentication for mobility signalling will now be described. For example, in Mobile IPv6 the CN sends a random number through the Home Agent (HA) and the secure tunnel between the HA and the MN, reducing the number of nodes that can overhear the random number. As another example, a fully secure end-to-end protocol, such as the Host Identity Protocol (HIP) [RFC5201, RFC5202] can be used to provide message authentication. Any such method can be used with the present invention.

However, using the iBFs creates additional possibilities, as receiving a packet with a know iBF provides reasonable assurance that the packet was sent by either the claimed source node (or by another, attacking node along the path).

Consider now the following, well-known hash-chains-based protocol between an MN and a new CN that the MN has not had a contact with earlier:

1. The MN generates a hash chain, with the hash anchor H_{MN}. That is,

H_{MN}=H(H(H( . . . H(H(random)) . . . )))

where the hash function H is applied repeatedly to an initial random seed. To use the H_{MN} as a hash chain, the generator stores all the intermediate values and reveals them one-by-one, starting from the immediately previous value, the hash of which H_{MN} is.

2. The MN sends a packet to the CN using hop-by-hop routing. The packet includes both a “collecting” iBF and the hash anchor H_{MN}. While sending a packet containing a hash anchor is well known, the combination of sending a “collecting” iBF and the hash anchor is novel.

3. The CN receives the packet from the MN. The packet now contains a routable iBF in the “collecting” iBF field, and the hash anchor H_{MN}.

Assuming that the forwarding nodes along the path are honest in the sense that they have not tampered with the hash anchor and have collected the iBF as defined above, the CN can now make the plausible assumption that there is an MN, wanting to talk to it, that sent the just received packet, that holds the other values in the hash chain H_{MN}, and, novel to this invention, that is reachable by sending the packets with the newly received iBF. The CN may then send packets to the MN using the iBF.

If the CN requires more security, it can use a well-known four-message protocol to verify that the MN (or some other node reachable with the iBF) indeed has the other values from the hash chain H_{MN}. To do so, the CN first sends a random number to the MN. The MN then replies with a hash value computed over the random number and the next previous value from the hash chain. The CN then replies with a message indicating that it has received the second message. The MN then sends the previous value from the hash chain in clear.

The CN then verifies that 1) the value it received in the second message of the four-message protocol exchange is indeed the hash value computed over the original random number and the previous value from the hash chain, as received in the fourth message of the four-message protocol exchange, and 2) that the value received in the fourth message of the four-message protocol exchange is indeed the previous value with respect to the hash anchor H_{MN}. However, from the mobility signalling security point of view this four message protocol can be considered as optional.

It is now possible to bind the iBF to the hash anchor within this four-message protocol, for example, in the following manner. Instead of computing the hash value over only the random number and the next previous value of the hash chain for the second message of the four-message protocol, the MN hashes the random number, the iBF, and the next previous value from the hash chain, and sends this in the second message of the four-message protocol. As the CN receives the previous value from the hash chain in the fourth message of the four message protocol, the CN may now verify the hash over the random number, the iBF, and the next previous value from the hash chain. With this protocol the CN can make a plausible assumption that the MN sees the same iBF that it sees.

From now on, the statistically unique hash anchor H_{MN} acts as a pseudonym for the mobile node. It is noteworthy that from the mobility signalling security point of view, such a stable pseudonym is enough. The “real” identity of the mobile node is not important; see [RFC 4225] for details.

4. As the MN moves to a new location, it sends a packet to the CN using hop-by-hop routing. This packet includes a “collecting” iBF field, the hash anchor H_{MN}, (to identify the MN), and the next unused previous value from the hash chain.

As the CN receives this packet, it can use the hash anchor H_{MN} to identify the MN as an already known MN, and use the next unused previous value to verify that the MN has indeed sent the message (or otherwise sent some other message from which the value was copied from).

The presented method is clearly vulnerable to en-route man-in-the-middle attacks, but so is the return routability method used in Mobile IPv6.

Supporting make-before-break mobility and bi-casting will now be described. In some cases an MN may be able to receive packets at multiple locations at the same time; for example, during a so-called “soft handover” it may first establish connectivity at a new location, and only somewhat later loose connectivity at its old location.

In such a situation, the iBF-based forwarding provides the possibility of bi-casting packets simultaneously to the old and new locations. When an MN indicates that such bi-casting is desirable, the Flow ID must be defined in a way allowing the same Flow ID to be used both at the old and at the new locations. Once the situation is so, the CN can simply take a binary bitwise OR of the old iBF (“F” in FIG. 4) and the new iBF (“G” in FIG. 4), and send packets using the result. Due to the multicasting capability of iBFs, the packets will be delivered both to the old and the new location.

Thus, if the underlying network infrastructure permits, the invention makes it possible to send packets simultaneously to the old (current) location of a mobile host and to the new (soon-to-be) location of a mobile host. The invention thus allows the overall resilience of mobility signalling to be enhanced. For example, in real time traffic the mobile host is likely to miss fewer packets if such bi-casting is supported (although there may be an increased risk of false positives). (As is well known, when a Bloom filter is queried there is a risk of a “false positive”, namely that the query will incorrectly identify an item as being present in the set encoded in the Bloom filter.)

As can be seen from the above description, the present invention may provide one or more of the flowing advantages:

Bi-directional iBFs. Compared to PCT/EP 2009/62785, the invention teach how to construct a bi-directional iBF instead of iBFs being unidirectional, by first ordering the input parameters fed to the so-called Z-function described in FIG. 2(a) into an order that is independent of packet-direction, so that the Z-function returns the same LIT for all packets on a flow, independent on their direction.

Hop-by-hop collection of iBFs. The invention uses the Bloom Filter's property that elements can be added to a Bloom Filter in any order to introduce the novel method of collecting forward, backward, and bi-directional iBFs incrementally, at a number of nodes, instead of computing the iBF at a single node. Furthermore, we teach how to use any existing hop-by-hop routing protocol, such as the Internet Protocol (IP), to guide signalling packets through the right path so that a right unique, flow-specific iBF is collected over the path.

Faster mobility signalling. Finally, and perhaps most importantly, the invention teaches how to use iBF-based forwarding and hop-by-hop iBF collection in the context of node-mobility signalling, allowing a CN to start sending to the MN's new location immediately after receiving a single packet from the MN sent through the new, after-movement, location, without any danger of flooding attacks. This is not possible in previous mobility protocols—for example the so-called credit based protocols, while allowing the CN to immediately send to MN's new location after receiving a single message, merely mitigate flooding attacks instead of eliminating the possibility of launching one.

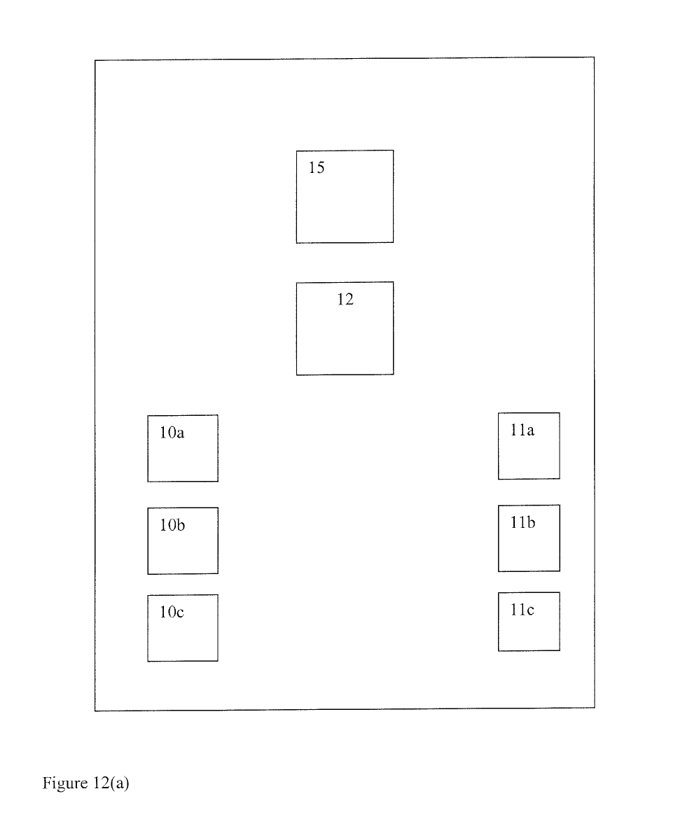

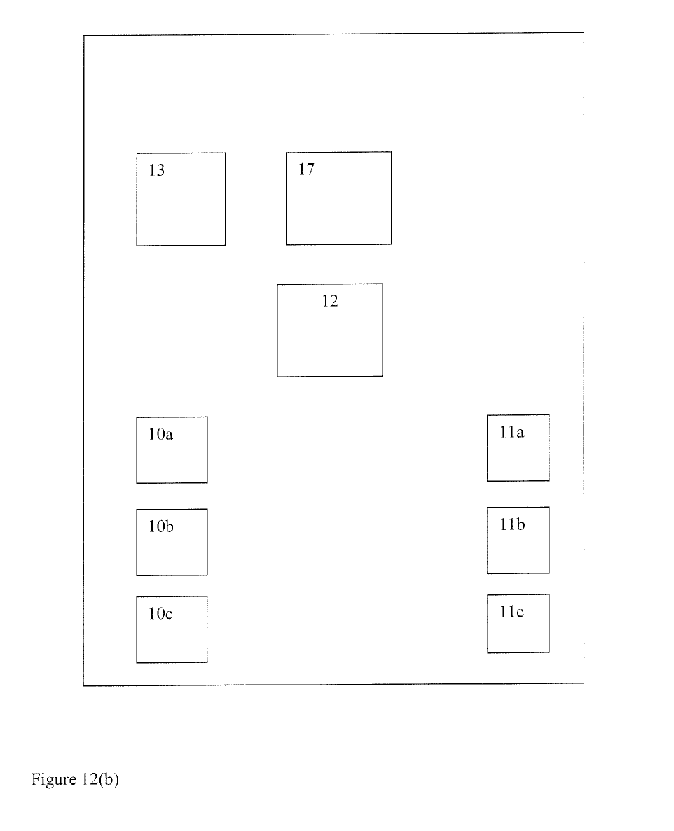

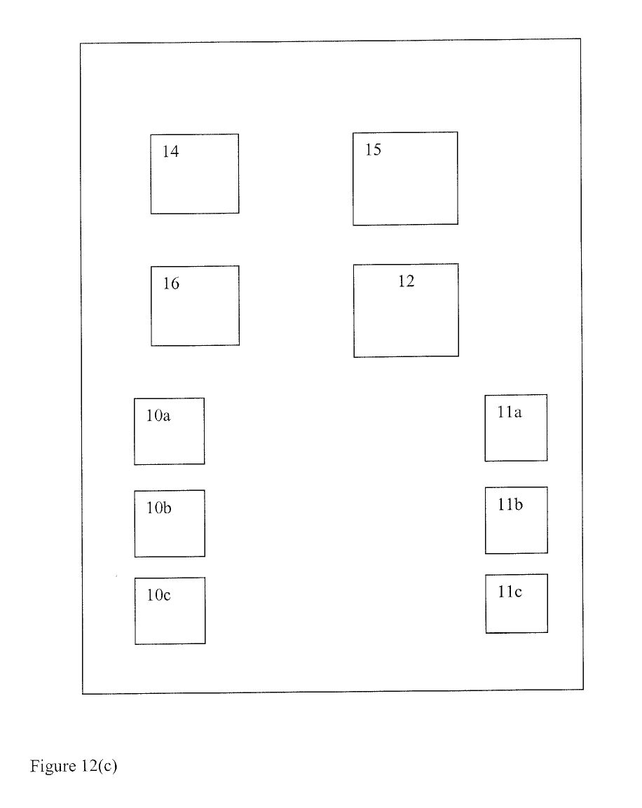

FIG. 12(a) is a schematic block diagram of a network node that is able to acts as a first end host 4 such as host A in FIG. 3. The node 9 contains a plurality of input ports 10a, 10b, 10c and a plurality of output ports 11a, 11b, 11c. (The ports are shown as either input ports or output ports for simplicity, but in principle a port could act as both an input port and an output port.) The node 9 further contains an iBF insertion module 15, that inserts a collecting iBF, with all entries initialised to zero, into a packet. The routing module 12 then directs the packet to the appropriate output interface, to send the packet along the path towards the second end host.

Where the invention is applied to a bidirectional iBF, the node 9 of FIG. 12(a) may further include a retrieval module (similar to retrieval module 16 of FIG. 12(c)). When a packet from the second end host is received at one of the input ports 10a, 10b, 10c, the retrieval module may then retrieve the iBF from the packet, for example for storage so that it is available for subsequent routing.

The node 9 of FIG. 12(a) may contain further components such as the module 13 of FIG. 2(b) for dynamic computation of LITs and/or a memory 14, but these additional components have been omitted for clarity.

FIG. 12(b) is a schematic block diagram of a network node that is able to acts as a forwarding node such as one of nodes 5, 6, 7 of FIG. 3. The node 9 contains a plurality of input ports 10a, 10b, 10c and a plurality of output ports 11a, 11b, 11c. (The ports are shown as either input ports or output ports for simplicity, but in principle a port could act as both an input port and an output port.) The node 9 further contains an LIT insertion module 17, that inserts an LIT into a collecting iBF included in a packet received at one of the input ports 10a, 10b, 10c. The routing module 12 then directs the packet to the appropriate output interface, to forward the packet along the path towards the second end host.

The node 9 of FIG. 12(b) may contain further components such as the module 13 of FIG. 2(b) for dynamic computation of LITs or a memory but, apart from the module 13 for dynamic computation of LITs, these additional components have been omitted for clarity.

FIG. 12(c) is a schematic block diagram of a network node that is able to act as a second end host 8 such as host B in FIG. 3. The node 9 contains a plurality of input ports 10a, 10b, 10c and a plurality of output ports 11a, 11b, 11c. (The ports are shown as either input ports or output ports for simplicity, but in principle a port could act as both an input port and an output port.) The node 9 further contains an iBF retrieval module 16. When a packet from the second end host is received at one of the input ports 10a, 10b, 10c, the retrieval module 16 may then retrieve the iBF from the packet, for example for storage in memory 14 so that it is available for subsequent routing. An iBF insertion module 15 may insert the retrieved iBF into a packet that is to be sent to the first end host, and the routing module 12 may then determine the appropriate output port for sending the packet towards the first end host.

The node 9 of FIG. 12(c) may contain further components such as the module 13 of FIG. 2(b) for dynamic computation of LITs, but these additional components have been omitted for clarity.

1-18. (canceled)

19. A network node comprising:
an insertion module configured to insert a collecting Bloom filter into a first packet;
a routing module configured to send the first packet towards a second network node by a hop-by-hop routing protocol;
one or more input ports configured to receive a second packet sent by the second network node, the header of the second packet containing a Bloom filter or a Bloom Filter equivalent that encodes forwarding information from the second network node to the network node; and
a retrieval module configured to determine, from the forwarding information in the Bloom filter or the Bloom Filter equivalent contained in the header of the second packet, a first hop for forwarding packets towards the second network node.

20. The network node of claim 19 wherein the network node comprises a mobile node configured to send the first packet following a change in location of the mobile node.

21. The network node of claim 20 wherein the retrieval node is further configured to:
extract a flow ID from the second packet; and
associate the Bloom Filter or the Bloom Filter equivalent with the extracted flow ID.

22. The network node of claim 19 wherein the Bloom filter or the Bloom Filter equivalent encodes packet flow-specific forwarding information.

23. A method of providing packet routing information, the method comprising:
at a first network node, inserting a collecting Bloom filter into a first packet;
sending the first packet from the first network node towards a second network node by a hop-by-hop routing protocol;
receiving, at the first network node, a second packet sent by the second network node, the header of the second packet containing a Bloom filter or a Bloom Filter equivalent that encodes forwarding information from the second network node to the first network node; and
determining, from the forwarding information in the Bloom filter or the Bloom Filter equivalent contained in the header of the second packet, a first hop for forwarding packets towards the second network node.

24. The method of claim 23, further comprising:
receiving, at the second network node, the first packet sent by the first network node containing the collecting Bloom filter; and
at the second network node, extracting, from the first packet, the Bloom Filter or the Bloom Filter equivalent containing forwarding information from the second network node to the first network node.

25. The method of claim 23, further comprising determining, from the forwarding information in the Bloom filter or the Bloom filter equivalent, a first hop for forwarding another packet from the first network node to the second network node.

26. The method of claim 23, further comprising:
receiving, at an intermediate node, the first packet sent by the first network node containing the collecting Bloom filter;
at the intermediate node, inserting into the collecting Bloom filter a link identifier tag representing a link over which the first packet is to be forwarded from the intermediate node; and
forwarding the first packet towards the second network node.

27. The method of claim 26, further comprising generating a bidirectional link identifier tag for insertion into the collecting Bloom filter.

28. The method of claim 23 wherein the Bloom filter or the Bloom Filter equivalent encodes forwarding information from the second network node to the first network node and forwarding information from the first network node to the second network node.

29. The method of claim 28, further comprising determining, from the forwarding information in the Bloom filter or the Bloom filter equivalent, a first hop for forwarding another packet from the second network node to the first network node.

30. The method of claim 28, further comprising determining, from the forwarding information in the Bloom filter or the Bloom filter equivalent, a first hop for forwarding another packet from the first network node to the second network node.

31. The method of claim 30, further comprising determining, from the forwarding information in the Bloom filter or the Bloom filter equivalent, a first hop for forwarding another packet from the second network node to the first network node.

32. A network node comprising:
one or more input ports configured to receive a packet sent by another network node according to a hop-by-hop routing protocol, the received packet containing a collecting Bloom filter;
a retrieval module configured to:
extract from the received packet a Bloom Filter or a Bloom Filter equivalent containing forwarding information from the network node to the another network node; and
determine, from the extracted Bloom Filter or the Bloom Filter equivalent, a first hop for routing a second packet towards the another network node.

33. The network node of claim 32, wherein the retrieval node is further configured to:
extract a flow ID from the received packet; and
associate the extracted Bloom Filter or the extracted Bloom Filter equivalent with the extracted flow ID.

34. The network node of claim 32, wherein:
the another network node comprises a mobile node;
the received packet was sent by the mobile node following a change in location of the mobile node; and
the Bloom Filter or the Bloom filter equivalent contains forwarding information from the network node to the mobile node at its new location.

35. The network node of claim 34, wherein the retrieval node is further configured to determine, from the forwarding information in the Bloom Filter or the Bloom filter equivalent, a first hop for forwarding another packet from the network node to the mobile node at its new location.

36. The network node of claim 34, further comprising one or more output ports configured to send another packet towards the mobile node using both the Bloom Filter or the Bloom filter equivalent containing forwarding information from the network node to the mobile node at its new location and another Bloom Filter or another Bloom filter equivalent containing forwarding information from the network node to the mobile node at an old location.

37. A network node comprising:
one or more input ports configured to receive a packet sent by a first node according to a hop-by-hop routing protocol, the packet containing a collecting Bloom filter;
an insertion module configured to insert into the collecting Bloom filter a link identifier tag representing a link over which the packet is to be forwarded from the network node;
one or more output ports configured to forward the packet towards a second node; and
a computation module configured to extract a flow ID from the received packet and to generate a bidirectional link identifier tag such that the link identifier tag is associated with the flow ID.

38. A method of routing packets to a mobile node, the method comprising:
sending, from a corresponding node, packets towards the mobile node using a first Bloom filter or a Bloom filter equivalent that encodes forwarding information towards the mobile node;
receiving, at the corresponding node, a packet sent from the mobile node to the corresponding node by a hop-by-hop routing protocol following a change in the location of the mobile node, the packet containing a collecting Bloom filter; and
extracting from the packet sent from the mobile node, at the corresponding node, a second Bloom Filter containing forwarding information from the corresponding node to the mobile node at its new location.

39. A computer program product stored in a non-transitory computer-readable medium for controlling a network node, the computer program product comprising instructions that, when executed by a processor, cause the processor to:
at a first network node, insert a collecting Bloom filter into a first packet;
send the first packet from the first network node towards a second network node by a hop-by-hop routing protocol;
receive, at the first network node, a second packet sent by the second network node, the header of the second packet containing a Bloom filter or a Bloom Filter equivalent that encodes forwarding information from the second network node to the first network node; and
determine, from the forwarding information in the Bloom filter or the Bloom Filter equivalent contained in the header of the second packet, a first hop for forwarding packets towards the second network node.

40. The computer program product of claim 39, further comprising instructions that, when executed by the processor, cause the processor to:
receive, at the second network node, the first packet sent by the first network node containing the collecting Bloom filter; and
at the second network node, extract, from the first packet, the Bloom Filter or the Bloom Filter equivalent containing forwarding information from the second network node to the first network node.

41. The computer program product of claim 39, further comprising instructions that, when executed by the processor, cause the processor to:
receive, at an intermediate node, the first packet sent by the first network node containing the collecting Bloom filter;
at the intermediate node, insert into the collecting Bloom filter a link identifier tag representing a link over which the first packet is to be forwarded from the intermediate node; and
forward the first packet towards the second network node.

42. The computer program product of claim 41, wherein the instructions further cause the processor to generate a bidirectional link identifier tag for insertion into the collecting Bloom filter.

43. The computer program product of claim 39 wherein the Bloom filter or the Bloom Filter equivalent encodes forwarding information from the second network node to the first network node and forwarding information from the first network node to the second network node.

44. The computer program product of claim 43, wherein the instructions further cause the processor to determine, from the forwarding information in the Bloom filter or the Bloom filter equivalent, a first hop for forwarding another packet from the second network node to the first network node.

45. The computer program product of claim 43, wherein the instructions further cause the processor to determine, from the forwarding information in the Bloom filter or the Bloom filter equivalent, a first hop for forwarding another packet from the first network node to the second network node.

46. The computer program product of claim 45, wherein the instructions further cause the processor to determine, from the forwarding information in the Bloom filter or the Bloom filter equivalent, a first hop for forwarding another packet from the second network node to the first network node.

47. A computer program product stored in a non-transitory computer-readable medium for controlling a network node, the computer program product comprising instructions that, when executed by a processor, cause the processor to:
send, from a corresponding node, packets towards the mobile node using a first Bloom filter or a Bloom filter equivalent that encodes forwarding information towards the mobile node;
receive, at the corresponding node, a packet sent from the mobile node to the corresponding node by a hop-by-hop routing protocol following a change in the location of the mobile node, the packet containing a collecting Bloom filter; and
extract from the packet sent from the mobile node, at the corresponding node, a second Bloom Filter containing forwarding information from the corresponding node to the mobile node at its new location.
